(19) United States
(12) Patent Application Publication
(10) Pub. No.: US 2012/0273050 A1
(43) Pub. Date: Nov. 1, 2012

(54) Automatic Shutoff Drain

(75) Inventors: Kent A. Metzger, Gays, IL (US); Neil E. Bowsher, Sullivan, IL (US)

(73) Assignee: K&N Innovations, LLC, Sullivan, IL (US)

(21) Appl. No.: 13/455,247

(22) Filed: Apr. 25, 2012

Related U.S. Application Data
(60) Provisional application No. 61/518,031, filed on Apr. 28, 2011.

(51) Int. Cl. F16K 17/40

(52) U.S. Cl. 137/2; 137/67

(57) ABSTRACT

An automatic shutoff drain remains open to allow the flow of aqueous liquids, but automatically closes if a non-aqueous liquid enters. The drain has four primary components: (1) a conduit having an inlet and an inner orifice; (2) a closing member having an open position that is spaced apart from the orifice to allow the flow of liquid through the conduit and having a closed position that seals the orifice to prevent the flow of liquid through the conduit; (3) a fusible link made from a material that remains intact when immersed in water and that degrades when immersed in a non-aqueous liquid; and (4) a mechanism that restrains the closing member in the open position when the fusible link is intact and allows the closing member to move to the closed position when the fusible link degrades.

### CROSS-REFERENCE TO RELATED APPLICATION

This application claims the benefit of U.S. Provisional Application Ser. No. 61/518,031, Apr. 28, 2011.

### FIELD OF THE INVENTION

This invention relates to drains. More particularly, this invention relates to drains having an automatic shutoff capability.

### BACKGROUND OF THE INVENTION

Roads, parking lots, the floors of buildings, and other surfaces often include drains for the removal of rainwater and other water overflows. Water entering a drain flows through a drainage system to a sewer system, a body of water, or other destination. A drain typically consists of a cylindrical conduit with a grate over the upper opening to prevent large objects from entering. The term “drain” is used herein to include conduits at the entrances of drainage systems as well as similar conduits at other locations in drainage systems. Drains of many different designs and materials are in use.

Contaminant liquids can enter a drain because of spills or other accidents and can cause damage at the destination of the drainage system. For example, untreated contaminant liquids can pollute bodies of water. As another example, water treatment plants that are designed to handle rainwater and sewage can be damaged if contaminant liquids enter the drainage system. Common contaminant liquids include non-aqueous liquids such as petroleum and its by-products (e.g., fuel oil, kerosene, aviation fuel, hexane, diesel fuel, gasoline, etc.), industrial chemicals (e.g., ethanol, benzene, acetone, etc.), and the like.

Drains have also been disclosed that allow water to enter, but close automatically if a contaminant liquid begins to enter. These automatic shutoff drains communicate with sensors that detect the presence of a contaminant liquid. When a contaminant is detected by a sensor, an electrical signal is sent to the drain and a device such as a solenoid or motor is energized to close the drain. Examples of such drains are disclosed in Shannon, U.S. Pat. No. 5,383,745, Jan. 24, 1995; Deming, U.S. Pat. No. 5,582,720, Dec. 10, 1996; and Colson, U.S. Pat. No. 6,558,077, May 6, 2003. These drains are susceptible to a variety of malfunctions in the sensors, the electrical closing mechanisms, and the power supply.

Drains have been disclosed that contain cartridges of an absorption media that filter out small amounts of contaminant hydrocarbons from an aqueous stream and that, when exposed to a hydrocarbon spill, form a plug to prevent any further flow through the drain. Examples of such drains are disclosed in Gannon, U.S. Pat. No. 6,503,390, Jan. 7, 2003; and Muir et al., U.S. Pat. No. 7,014,755, Mar. 21, 2006. These drains have two major disadvantages. First, they are susceptible to premature plugging. Second, replacement of a plugged absorption media cartridge is expensive.

Accordingly, there is a demand for an improved automatic shutoff drain. More particularly, there is a demand for such a drain that has no sensors or electrical components, that forms an effective seal when exposed to a spill of a non-aqueous liquid contaminant, and that is inexpensively reset after a spill.

### SUMMARY OF THE INVENTION

The general object of this invention is to provide an improved automatic shutoff drain. A more particular object is to provide an automatic shutoff valve that has no sensors or electrical components, that forms an effective seal when exposed to a spill of a non-aqueous liquid contaminant, and that is inexpensively reset after a spill.

We have invented an automatic shutoff drain that remains open to allow the flow of aqueous liquids and that automatically closes if a non-aqueous liquid enters. The drain comprises: (a) a conduit having an inlet and an inner orifice; (b) a closing member having an open position that is spaced apart from the orifice to allow the flow of liquid through the conduit and having a closed position that seals the orifice to prevent the flow of liquid through the conduit, the closing member being biased toward the closed position by a force; (c) a fusible link made from a material that remains intact when immersed in water and that degrades when immersed in a non-aqueous liquid; and (d) a mechanism that restrains the closing member in the open position when the fusible link is intact and allows the closing member to move to the closed position when the fusible link degrades.

The drain of this invention allows the flow of aqueous liquids, but automatically closes if a contaminant non-aqueous liquid enters. The drain is very reliable because it has no sensors or electrical components and requires no power. The drain forms an effective seal when exposed to a spill of a non-aqueous liquid contaminant and is inexpensively reset after a spill.

### BRIEF DESCRIPTION OF THE DRAWINGS

FIG. 1 is a sectional front elevation view of a first embodiment of the drain of this invention in the open position.

FIG. 2 is a sectional front elevation view thereof in the closed position.

FIG. 3 is a sectional front elevation view of a second embodiment of the drain of this invention in the open position.

FIG. 4 is a sectional front elevation view thereof in the closed position.

FIG. 5 is a front elevation view of a third embodiment of the drain of this invention in the open position.

FIG. 6 is a sectional side elevation view thereof

FIG. 7 is a front elevation view thereof in the closed position.

FIG. 8 is a sectional side elevation view thereof in the closed position.

FIG. 9 is a sectional front elevation view of a fourth embodiment in the open position.

FIG. 10 is a top view thereof in the closed position.

FIG. 11 is a sectional front elevation view thereof.

### DETAILED DESCRIPTION OF THE INVENTION

### 1. The Invention in General

This invention is a shutoff drain that allows the flow of aqueous liquids, but that automatically closes if a non-aqueous liquid enters. The drain thus acts also as a valve by controlling the movement of liquid by opening or closing. The drain comprises a conduit, a closing member having open and closed positions, a fusible link, and a mechanism that restrains the closing member in the open position when the fusible link is intact and allows the closing member to move to the closed position when the fusible link degrades. The drain can take many different forms. The embodiment of the drain that is preferred for a given situation depends on many factors, including the environment (the existing drainage system, the anticipated contaminant liquid, flow rates, etc.), the degree to which the closing member must completely stop flow of the contaminant liquid through the drain when in the closed position, durability, and cost. Four embodiments are illustrated in the drawings and each is preferred for different situations. Each embodiment is discussed in turn.

### 2. The First Embodiment (Plug Drain)

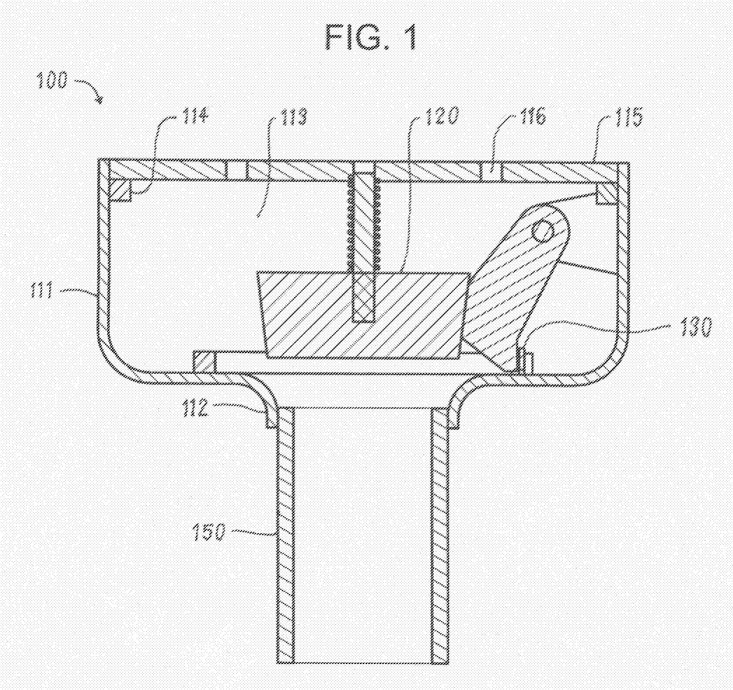

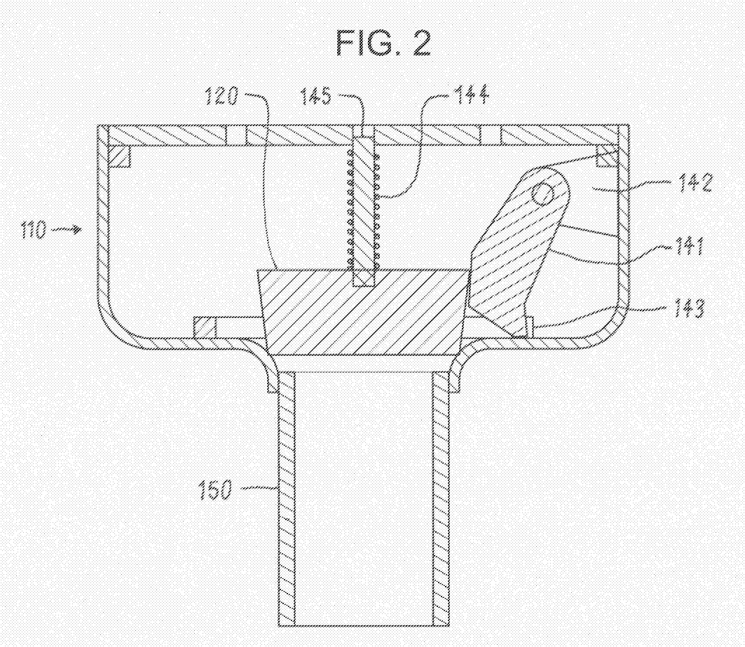

Referring first to FIGS. 1 and 2, the first embodiment of the automatic shut-off drain 100 of this invention comprises a conduit 110, a closing member 120, a fusible link 130, and a mechanism 140 for restraining the closing member. The closing member of this drain is a plug so the first embodiment is known as a plug drain. This drain is preferred in situations where durability and low cost are of primary importance. Each of the components of this drain is discussed in detail below.

### 3. The Conduit

The conduit 110 forms the body of the drain. In the first embodiment, the conduit accepts a vertical flow of liquid and is mounted with its inlet flush in the floor or ground. The conduit connects to a vertical pipe 150 that is part of the drainage system. In the first embodiment, the conduit is cylindrical with an upper portion 111 having one diameter that tapers inwardly to a lower portion 112 having a smaller diameter to form an inner orifice. The size, shape, and structure of the lower portion of the conduit are matters of choice that are generally chosen to mate with the vertical pipe at a particular installation. The upper opening 113 of the conduit preferably contains a ledge 114 for accepting a removable grate 115. The grate contains openings 116 that allow liquids to enter but restrain large objects. Suitable materials for the conduit include non-corrosive metals such as coated cast iron, stainless steel, and bronze, and molded plastics such as polyvinyl chloride (PVC), acrylonitrile butadiene styrene (ABS), polypropylene, polyethylene, and the like.

### 4. The Closing Member

The closing member 120 seals the orifice of the conduit and prevents the flow of liquid through the drain when in the closed position shown in FIG. 2. When the closing member is held in the open position as shown in FIG. 1, the closing member is spaced apart from the orifice of the conduit and flow through the drain is allowed. The shape, size, and material of the closing member are matters of choice that are generally chosen to provide an effective and durable seal. In the first embodiment, the closing member is a tapered plug that seals the conduit by fitting into the orifice. The plug is formed of a material that is impervious to water and to any non-aqueous contaminant liquids that are anticipated. The preferred material for the closing member depends on the environment, the anticipated contaminants, and other factors. Resilient materials such as rubber and other elastomers form better seals, but metals are more durable.

### 5. The Fusible Link

The fusible link 130 of the first embodiment is a small piece of material that holds the closing mechanism in the position shown in FIG. 1. The fusible link is made of a material that is impervious to an aqueous liquid (i.e., it remains intact when immersed in water) but is degraded when immersed in a non-aqueous contaminant liquid that may be spilled in the vicinity. The degradation preferably occurs rapidly so the drain closes rapidly and the amount of contaminant liquid passing through the drain is minimized.

The fusible link can take many different shapes and sizes. In the first embodiment, the fusible link is a homogeneous, solid piece of material that is degraded by softening and dissolution by the non-aqueous liquid. A second type of suitable fusible link is a multiple piece structure having components of the same or different materials. The components are fused together, glued together with adhesive, joined together in a mechanical connection (e.g., one component is press fitted into a second component), or the like to form a fusible link of the desired shape and size. The multiple piece structure is unaffected by water but is degraded by one or more non-aqueous liquids. Either component may degrade or the adhesive connection may degrade. One component may degrade in one non-aqueous liquid while another component degrades in a different non-aqueous liquid. Such a fusible link is preferred for use where different types of non-aqueous liquids may be spilled. A third type of suitable fusible link is a lattice (web) type structure having connections between the individual filaments (threads) that are unaffected by water but are degraded by one or more non-aqueous liquids.

The speed of degradation of the fusible link can be quantified by measuring the time for the fusible link to degrade when submerged in the contaminant liquid. For a solid fusible link, a sphere of the material having a diameter of 2 mm is preferably substantially completely dissolved in less than ten minutes when submerged in a large volume of the non-aqueous liquid at room temperature with gentle stirring. For fusible links consisting of multiple members joined together, the fusible link preferably loses at least 25 percent of its tensile strength in less than ten minutes when submerged in a large volume of the non-aqueous liquid at room temperature.

The choice of material for the fusible link depends on the non-aqueous material that may be spilled and on the speed at which the fusible link needs to degrade upon contact with the non-aqueous material. For example, drains near gasoline stations preferably contain a fusible link that degrades quickly in gasoline, drains near oil refineries preferably contain a fusible link that degrades quickly in crude petroleum or its by-products, drains near ethanol plants preferably contain a fusible link that degrades quickly in ethanol, etc.

A variety of materials that are degradable in common non-aqueous contaminant liquids are known in the art. Degradable materials are generally polymeric.

The Hildebrand solubility parameter is an effective predictor of what materials are degradable in a given non-aqueous liquid. The Hildebrand solubility parameter is defined as the square root of the cohesive energy density that is, in turn, defined as the energy required to vaporize one mole of a liquid. Hildebrand solubility parameters for polymeric materials and non-aqueous liquids are tabulated in many references, including CRC Handbook of Solubility Parameters and Other Cohesion Parameters by Allan F. M. Barton, CRC Press 1991.

The following table lists Hildebrand solubility parameters for some common polymers:

TABLE 1
Hildebrand Solubility Parameters for Polymers

| Polymer | Hildebrand Solubility Parameter (calories/cm³)^{1/2} |
|---|---|
| Polyethylene | 7.9 |
| Polypropylene | 8.2 |
| Polystyrene | 9.1 |

The following table lists Hildebrand solubility parameters for some common non-aqueous liquids:

TABLE 2
Hildebrand Solubility Parameters for Non-Aqueous Liquids

| Liquid | Hildebrand Solubility Parameter (calories/cm³)^{1/2} |
|---|---|
| N-Hexane | 7.2 |
| Benzene | 9.2 |
| Acetone | 9.8 |
| Ethanol | 12.9 |

Polymeric materials having a Hildebrand solubility parameter within two units (plus or minus) of a given liquid are generally degraded rapidly in the liquid. For example, Styrofoam foam, an expanded polystyrene foam, has a Hildebrand solubility parameter of about 9.1 (calories/cm³)^{1/2} and is especially degradable in benzene that has a Hildebrand solubility parameter of 9.2 (calories/cm³)^{1/2}.

### 6. The Mechanism

The mechanism 140 restrains the closing member in the open position when the fusible link is intact and allows the closing member to move to the closed position when the fusible link degrades. The closing mechanism is biased toward the closed position by a force. The force is the force of gravity, a mechanical force such as a spring or the like, or a combination thereof. In the first embodiment, the mechanism comprises an arm 141 pivotably connected to a first support 142. The fusible link is positioned between the arm and a second support 143. When the fusible link is intact, the plug is suspended a short distance above the orifice of the conduit by the arm. When the fusible link degrades, the arm pivots away which allows the plug to move downward to seal the orifice and the conduit. In the embodiment shown, the plug moves downward by the force of gravity and by a mechanical force supplied by a helical spring 144 around a post 145 that extends between the grate and a recess in the top of the closing member.

### 7. The Second Embodiment (Trap Door Drain)

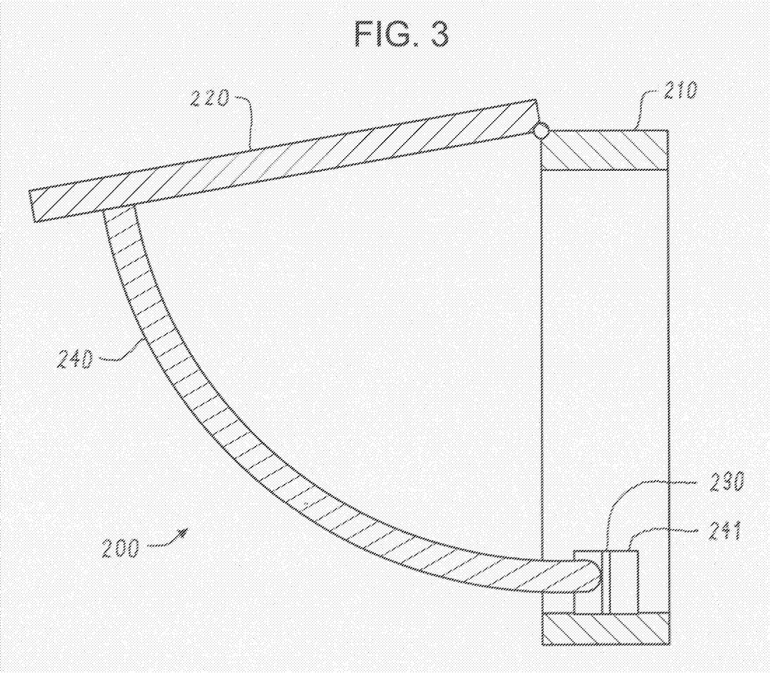

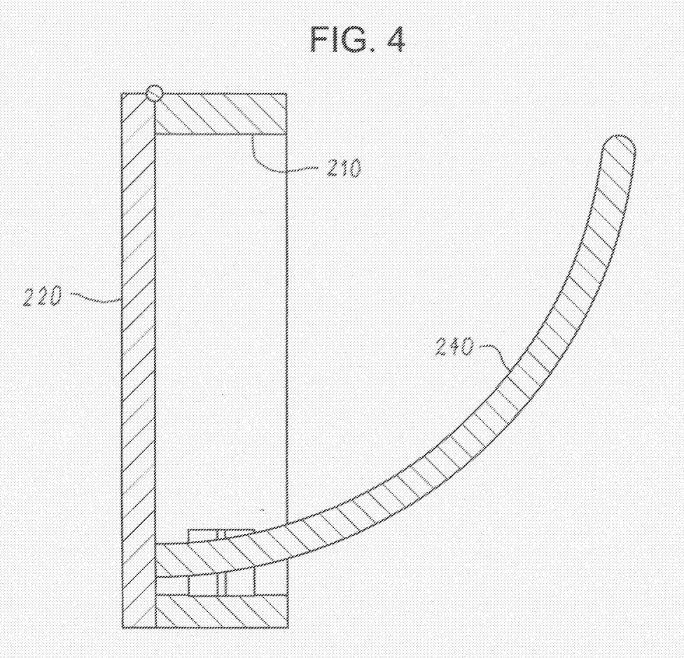

Referring now to FIGS. 3 and 4, the second embodiment 200 of the automatic shutoff drain of this invention differs from the first embodiment in that the conduit 210 is horizontal rather than vertical. It also differs in that the closing member 220 acts like a hinged trap door to close the opening of the conduit rather than fitting into the orifice as a plug. Referring to FIG. 3, the closing member is held in an open position by a closing mechanism consisting of a curved arm 240 that rests against a fusible link 230 positioned in a housing 241 mounted to the inner wall of the conduit. The fusible link may take the form of a wafer or disc that rests in vertical slots in two spaced apart blocks forming the housing. When a non-aqueous contaminant liquid enters and degrades the fusible link, the trap door pivots to the closed position shown in FIG. 4. The second embodiment is known as a trap door drain because its closing mechanism calls to mind that of a trap door. This drain is preferred in situations where low cost is important and where the existing drain system can accommodate a horizontal drain.

### 8. The Third Embodiment (Guillotine Drain)

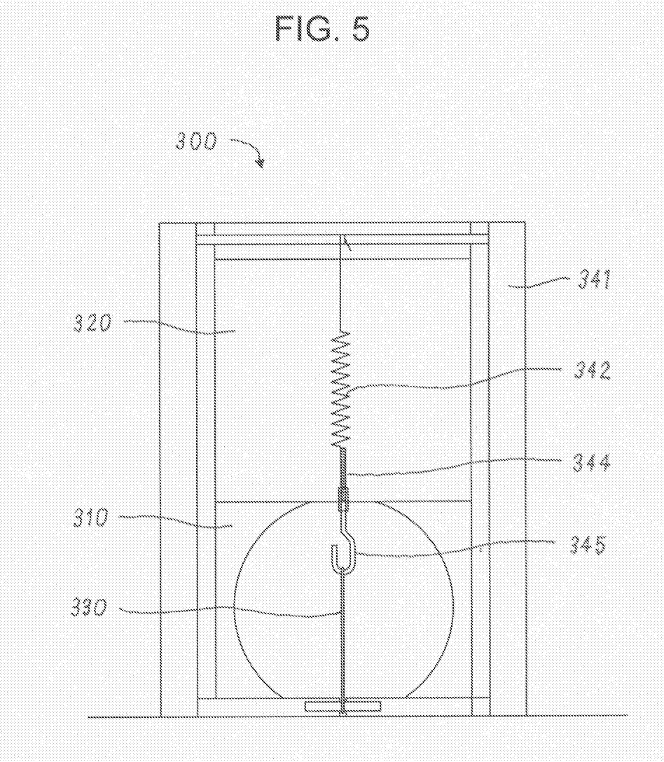

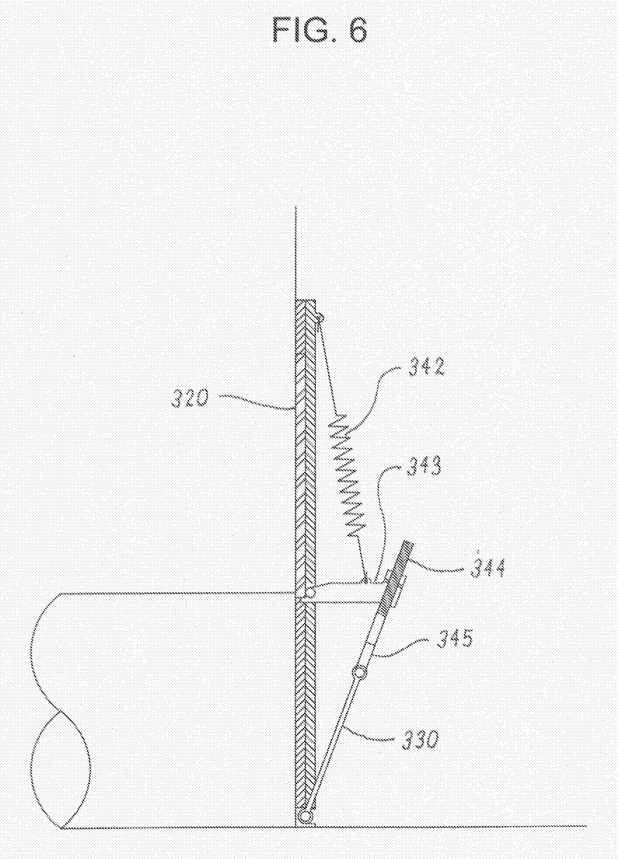

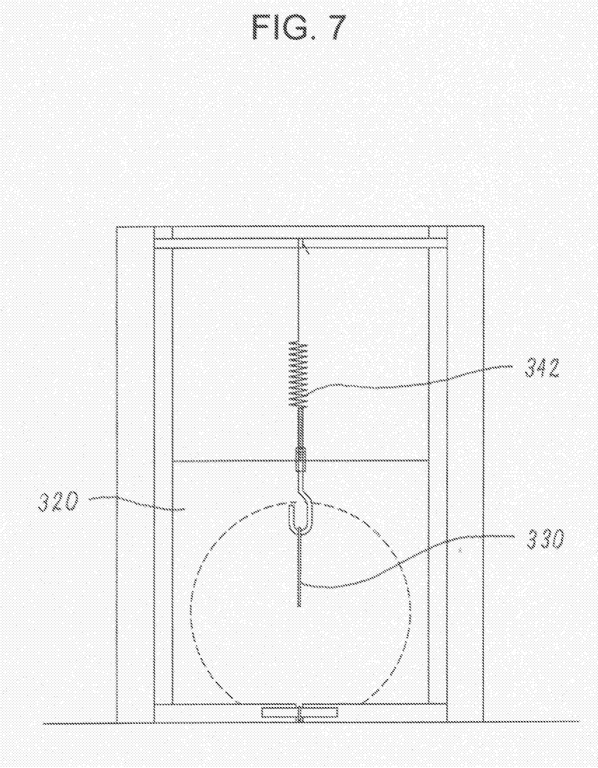

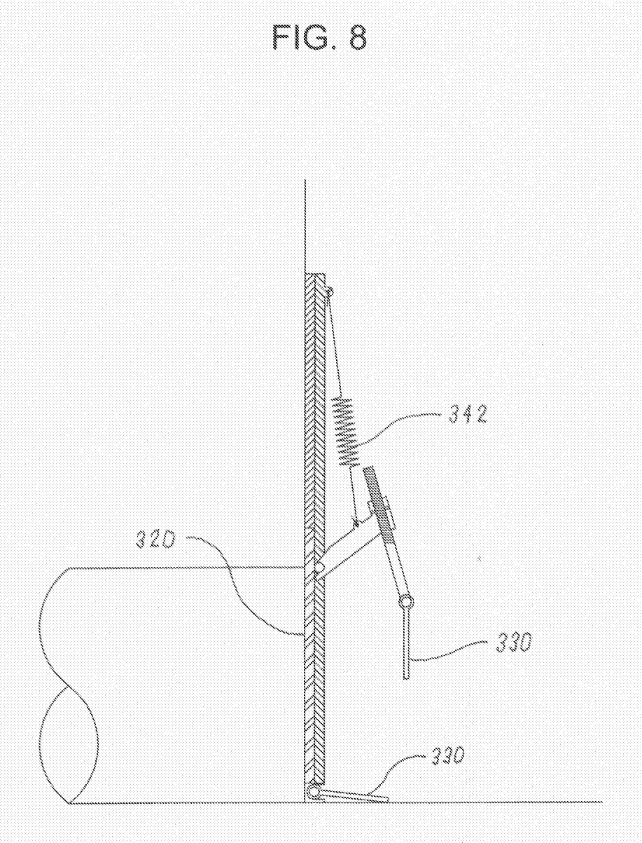

Referring now to FIGS. 5 to 8, the third embodiment 300 of the automatic shutoff drain of this invention is similar to the second embodiment in that the conduit 310 is horizontal and in that the closing member 320 is a door. However, it differs from the second embodiment in that the fusible link 330 is elongated and in that closing mechanism 340 includes tracks 341 (also known as door guides) along which the door moves. The movement of the door calls to mind the movement of the blade in a guillotine so this embodiment is known as the guillotine drain. In the open position shown in FIGS. 5 and 6, the door is supported in the elevated position by a linkage comprising a support spring 342, a trigger 343, a threaded rod 344 passing into the trigger, a hook 345, and the elongated fusible link. When a non-aqueous contaminant liquid enters and degrades the fusible link, the door drops down in the tracks and seals the conduit. This drain is preferred in situations where an effective seal is important and where the existing drain system can accommodate a horizontal drain.

### 9. The Fourth Embodiment (Bear Trap Drain)

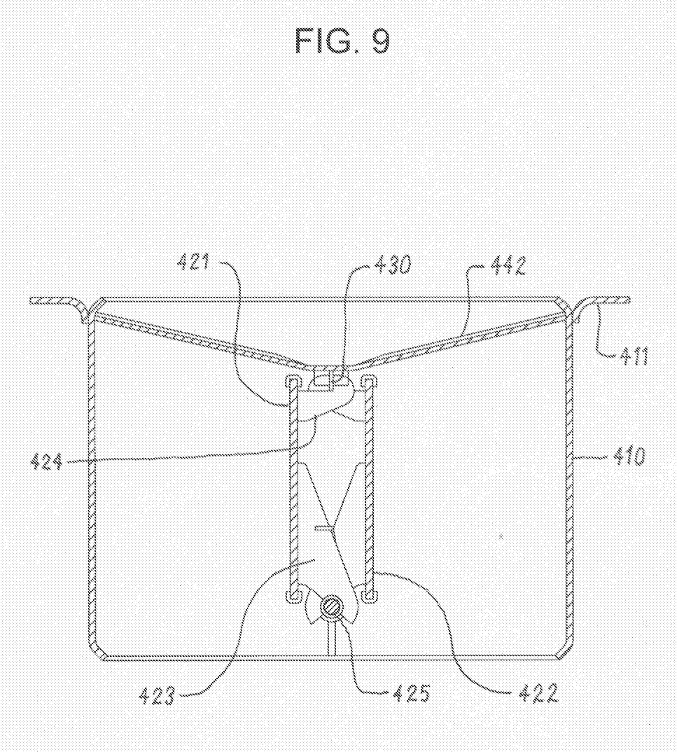

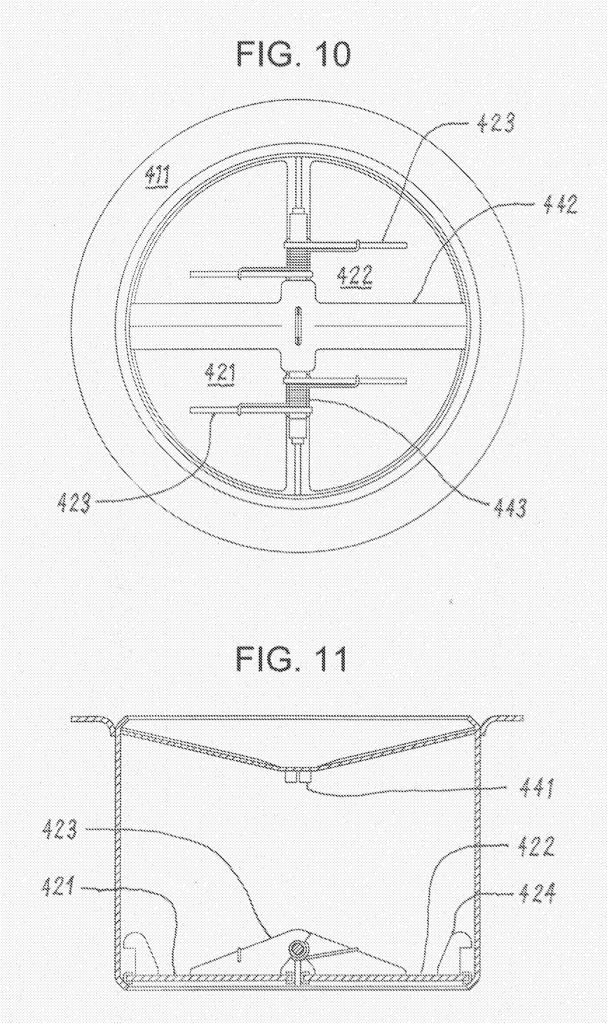

Referring now to FIGS. 9 to 11, the fourth embodiment 400 of the automatic shutoff drain of this invention contains a conduit 410, a closing member 420 including two semi-circular doors 421 and 422, a fusible link 430, and a closing mechanism 440. This drain is especially suited for placement into an existing drain. The lip 411 of the conduit rests on the grate ledge of the drain. Each door includes two arms 423 and a hook 424. The arms pivot about a shaft 425. The doors are positioned vertically when the drain is open and are held in position by the hooks that are held against the fusible link. The fusible link is positioned between supports 441 that are, in turn, suspended from a ramp 442 extending across the conduit. V-shaped springs 443 surround the shaft and engage the arms of the door to bias the doors to the horizontal position, away from each other. The doors snap to the horizontal position to close the drain when the fusible link is degraded. The movement of the doors calls to mind the movement of the jaws in a bear trap, although in reverse. The springs in a bear trap bias the jaws toward each other, rather than away from each other, to close the trap. In the embodiment shown, the edges of the doors contain a flexible bumper that helps to create a better seal when the mechanism closes. This drain is preferred in situations where an effective seal is of primary importance.

### 10. Other Embodiments

A wide variety of other closing members and mechanisms are suitable. The preferred closing member and mechanism for a given application depends on many factors, including the environment (the existing drainage system, the anticipated contaminant liquid, flow rates, etc.), the degree to which the closing member must completely stop flow of the contaminant liquid through the drain when in the closed position, durability, and cost.

### 11. Installation and Use

The installation and use of the automatic shutoff drain of this invention can now be considered. The drain is installed at the entrance, exit, or any other point in a drainage system that is readily accessible so that the fusible link can be easily replaced. The drain is installed in a conventional manner with the fusible link in place and the mechanism holding the closing member in the open position. There is no need to connect the drain to a power source. Once installed, the drain remains open as long as no substantial volume of contaminant non-aqueous liquid enters. However, if a spill occurs that allows a substantial volume of a non-aqueous liquid to enter, the fusible link is quickly degraded. The degradation of the fusible link allows the closing member to move to the closed position to prevent any further flow of the contaminant into the drainage system. The contaminant liquid can then be removed from the surface or other collection point and disposed of as desired. A new fusible link is then installed in the drain. If needed, the drain includes a trip flag or other suitable visual indicator so the position of the closing member (open or closed) can be quickly and easily determined from a distance.

### 12. Advantages

The automatic shutoff drain of this invention is extremely reliable because it has no sensors or electrical components that are prone to malfunction. It does not require electrical power so it can be installed anywhere and continues to function even if there is a failure in the supply of electrical power, either by a failure of the power grid or a failure of batteries. The automatic shutoff drain is inherently “fail safe” in that the closing member moves to the closed position if for any reason the fusible link degrades prematurely or otherwise fails. The automatic shutoff drain of this invention can be manufactured as a new item or can be produced by retrofitting an existing drain with the shutoff mechanism.

We claim:

1. An automatic shutoff drain that remains open to allow the flow of aqueous liquids and that automatically closes if a non-aqueous liquid enters, the drain comprising:
(a) a conduit having an inlet and an inner orifice;
(b) a closing member having an open position that is spaced apart from the orifice to allow the flow of liquid through the conduit and having a closed position that seals the orifice to prevent the flow of liquid through the conduit, the closing member being biased toward the closed position by a force;
(c) a fusible link made from a material that remains intact when immersed in water and that degrades when immersed in a non-aqueous liquid; and
(d) a mechanism that restrains the closing member in the open position when the fusible link is intact and allows the closing member to move to the closed position when the fusible link degrades.

2. The drain of claim 1 wherein the fusible link comprises a plurality of materials, at least one of which degrades when immersed in a non-aqueous liquid.

3. The drain of claim 1 wherein the closing member comprises a plug that seals the conduit by fitting into the orifice.

4. The drain of claim 1 wherein the closing member comprises a door that seals the conduit by covering the orifice.

5. The drain of claim 1 wherein the mechanism biases the closing member toward the closed position by the force of gravity.

6. The drain of claim 1 wherein the fusible link has a Hildebrand solubility parameter of about 7 to 10.

7. An automatic shutoff drain that remains open to allow the flow of aqueous liquids and that automatically closes if a non-aqueous liquid enters, the drain comprising:
(a) a conduit having a liquid inlet, a liquid outlet, and an inner orifice;
(b) a closing member having an open position that is spaced apart from the orifice to allow the flow of liquid through the conduit and having a closed position that seals the orifice to prevent the flow of liquid through the conduit;
(c) a fusible link positioned within the conduit such that it is immersed in liquid flowing through the conduit, the fusible link being of a material that degrades when immersed in a non-aqueous liquid;
(d) a means for restraining the closing member in the open position when the fusible link is intact; and
(e) a means for moving the closing member to the closed position if the fusible link degrades.

8. The drain of claim 7 wherein the fusible link comprises a plurality of materials, at least one of which degrades when immersed in a non-aqueous liquid.

9. The drain of claim 7 wherein the means for moving the closing member to the closed position comprises the force of gravity.

10. The drain of claim 7 wherein the means for moving the closing member to the closed position additionally comprises a mechanical force.

11. The drain of claim 7 wherein the fusible link comprises a solid piece of material.

12. The drain of claim 7 wherein the fusible link comprises a lattice.

13. A method for allowing the flow of an aqueous liquid and stopping the flow of a non-aqueous liquid into a drainage system, the method comprising:
(a) installing a drain at an entrance to the drainage system where the flow of an aqueous liquid and a non-aqueous liquid are anticipated, the drain comprising:
(i) a conduit having an inlet and an inner orifice;
(ii) a closing member having an open position that is spaced apart from the orifice to allow the flow of liquid through the conduit and having a closed position that seals the orifice to prevent the flow of liquid through the conduit, the closing member being biased toward the closed position by a force
(iii) a fusible link made from a material that remains intact when exposed to an aqueous liquid and that degrades when exposed to a non-aqueous liquid; and
(iii) a mechanism that restrains the closing member in the open position when the fusible link is intact and that moves the closing member to the closed position when the fusible link degrades.

14. The drain of claim 13 wherein the fusible link comprises a plurality of materials, at least one of which degrades when immersed in a non-aqueous liquid.

15. The method of claim 13 wherein the non-aqueous liquid has a Hildebrand solubility parameter and the fusible link has a Hildebrand solubility parameter within two units thereof.

16. The method of claim 13 wherein the force that moves the closing member to the closed position comprises the force of gravity and a mechanical force.

17. The method of claim 13 wherein the closing member comprises a plug.

18. The method of claim 13 wherein the closing member comprises a door.
